(19) United States
(12) Patent Application Publication
(10) Pub. No.: US 2014/0311826 A1
(43) Pub. Date: Oct. 23, 2014

(54) LADDER STABILIZATION DEVICE

(71) Applicant: Maureen Beardman, Youngstown, OH (US)

(72) Inventor: Maureen Beardman, Youngstown, OH (US)

(21) Appl. No.: 14/245,004

(22) Filed: Apr. 4, 2014

Related U.S. Application Data
(60) Provisional application No. 61/813,387, filed on Apr. 18, 2013.

(51) Int. Cl. E06C 7/46; E06C 7/10

(52) U.S. Cl. CPC E06C 7/46; E06C 7/10
USPC 182/107

(57) ABSTRACT

An integrated ladder stabilizing support that utilizes the flexibility and usefulness of a vehicle to provide for a safe support stabilizer for the base of a ladder. A flush user platform with an upstanding ladder abutment rail has a flat extending tire receiving portion for a vehicle tire to be parked securely anchoring the ladder stabilizing support of the ground. Adjustable tie down strap selectively engages and secures the ladder to the upstanding ladder stabilizing support once positioned there against for safety.

This application claims the benefit of U.S. Provisional Application No. 61/813,387, filed Apr. 18, 2013.

### BACKGROUND OF THE INVENTION

1. Technical Field

This invention relates to portable ladders and their use with ladder stabilizer attachments and devices.

2. Description of Prior Art

Prior art devices of this type have been directed to a variety of different ladder accessories that are attached to or used with a ladder to stabilize and help hold the ladder in elevated use position. Such devices directed to ladder base attachments can be seen in the following U.S. Patents; see U.S. Pat. No. 6,092,625, U.S. Patent Publications 2006/0124393, 2007/0056800 and 2012/0199416.

In U.S. Pat. No. 6,092,625 an anti-slip pad can be seen having a pad bracket that is clipped to the ladder rail providing for an adjustable support engagement surface anywhere along the ladder rails.

U.S. Patent Publication 2006/0124393 discloses a ladder support with a plurality of ground engagement spikes that are deployed to hold and support the ladder thereon during use.

U.S. Patent Publication 2007/0056800 claims a ladder safety surface by providing a slip resistant mat on which the feet of the ladder are positioned for use.

U.S. Patent Publication 2012/0199416 illustrates a ladder stabilizer with a base plate having an elevated ladder feet engagement rod onto which a bracket attached to the ladder feet are pivotally attached. A vehicle tire receiving platform provides a tire engagement surface to hold the stabilizer in place.

### SUMMARY OF THE INVENTION

A ladder stabilization device against which the ladder feet of an extension or similar ladder are braced for use. A user access support platform provides for a safe, flat, slip resistant surface for ladder egress with an adjustable ladder ring engagement strap system extending therefrom for securing the ladder in place there against. A vehicle tire engagement surface extends integrally from the access support platform onto which a vehicle is temporarily parked assuring ground engagement anchor thereof holding the ladder stabilization device in place for secure engagement of the ladder there against, as noted.

### DESCRIPTION OF THE DRAWINGS

FIG. 1 is a perspective view of the ladder stabilization device.

FIG. 2 is a top plan view thereof.

FIG. 3 is a front elevational view thereof.

FIG. 4 is an end elevational view on lines 4-4 of FIG. 1.

FIG. 5 is an end elevational view on lines 5-5 of FIG. 1.

FIG. 6 is a perspective view of the ladder stabilization device with a ladder positioned there against.

FIG. 7 is a perspective view of an alternate form of the ladder stabilization device with the ladder positioned and secured there against.

### DETAILED DESCRIPTION OF THE INVENTION

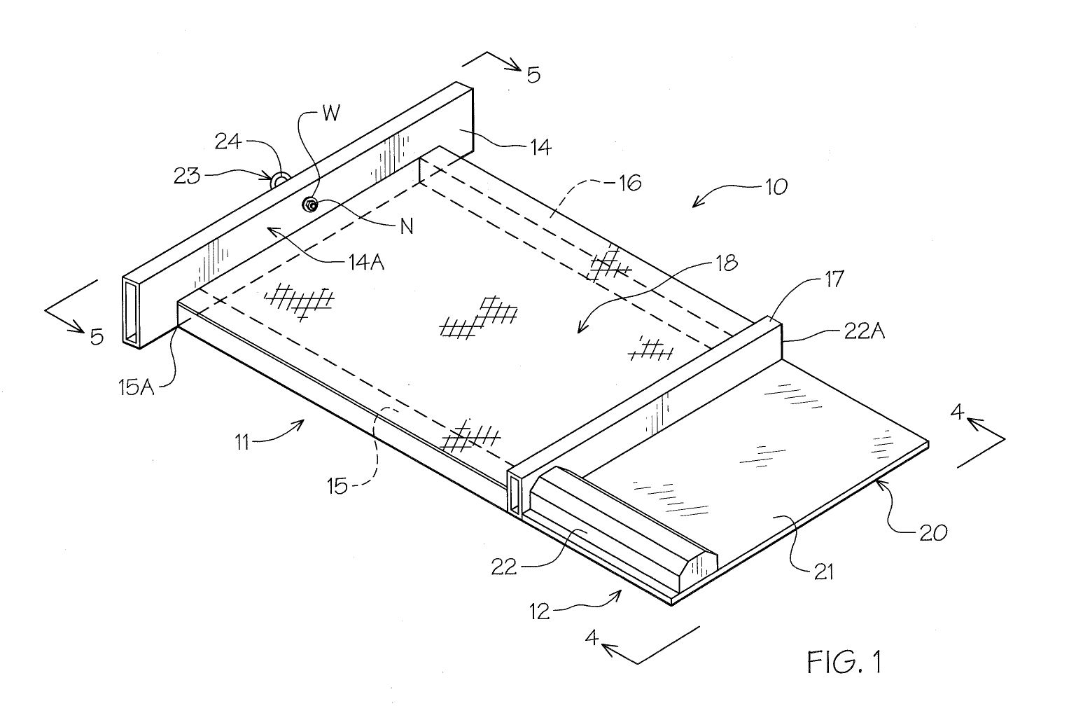

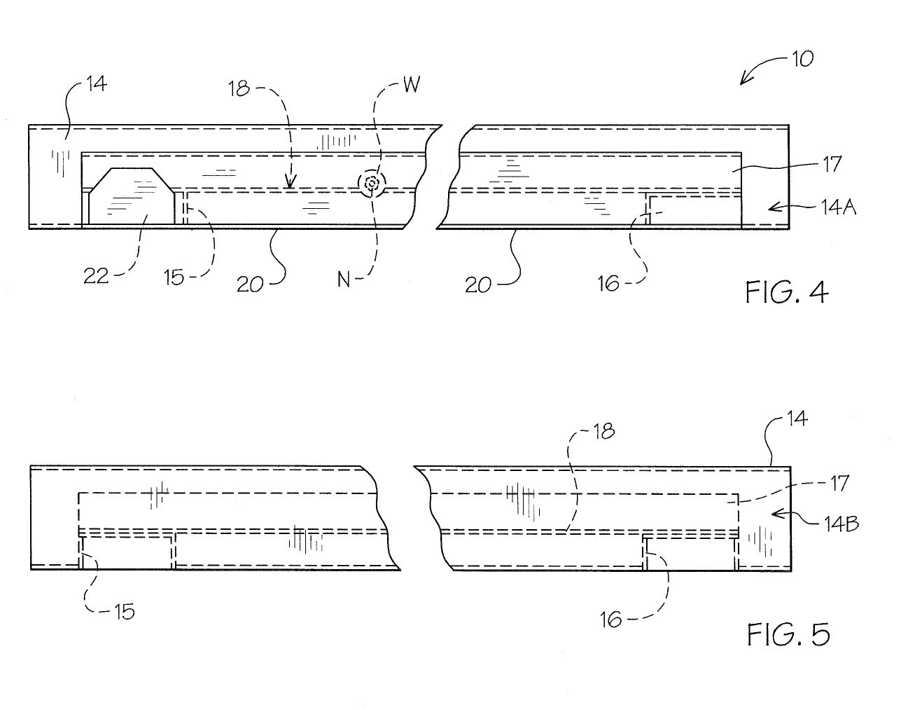

Referring to FIGS. 1-5 of the drawings, a ladder stabilization device 10 of the invention can be seen having a user access portion 11 and a vehicle tire engagement portion 12. The user access portion 11 has a main platform 13 defined by an upstanding ladder engagement rail 14 with a pair of spaced parallel side rails 15 and 16 extending at right angles therefrom. A bottom rail 17 interconnects the free ends of the side rails 15 and 16 with the main platform 13 surface having a textured base surface plate 18 overlying the respective side rails 15 and 16 defining a safe level and slip resistant field 19 of the main platform 13.

The rails 14-17 are in this example formed of extrusions, but can be of any suitable rail configuration as will be well understood by those skilled in the art.

The ladder engagement rail 14 in this example is placed on edge so as to be upstanding in relation to the corresponding extending side rails 15 and 16. The ladder engagement rail 14 is of a larger cross-section so as to ladder engagement height and extends beyond respective side rail end engagement points 15A and 16A therewith to accommodate different size ladders that may be used.

The vehicle tire engagement portion 12 comprises a tire platform 20 that extends from and is integral with the hereinbefore described main user access platform 13. The tire platform 20 has a parking plate 21 extending the width of the bottom base rail 17 and outwardly therefrom defining a generally rectangular tire receiving area in spaced relation from the ladder engagement rail 14.

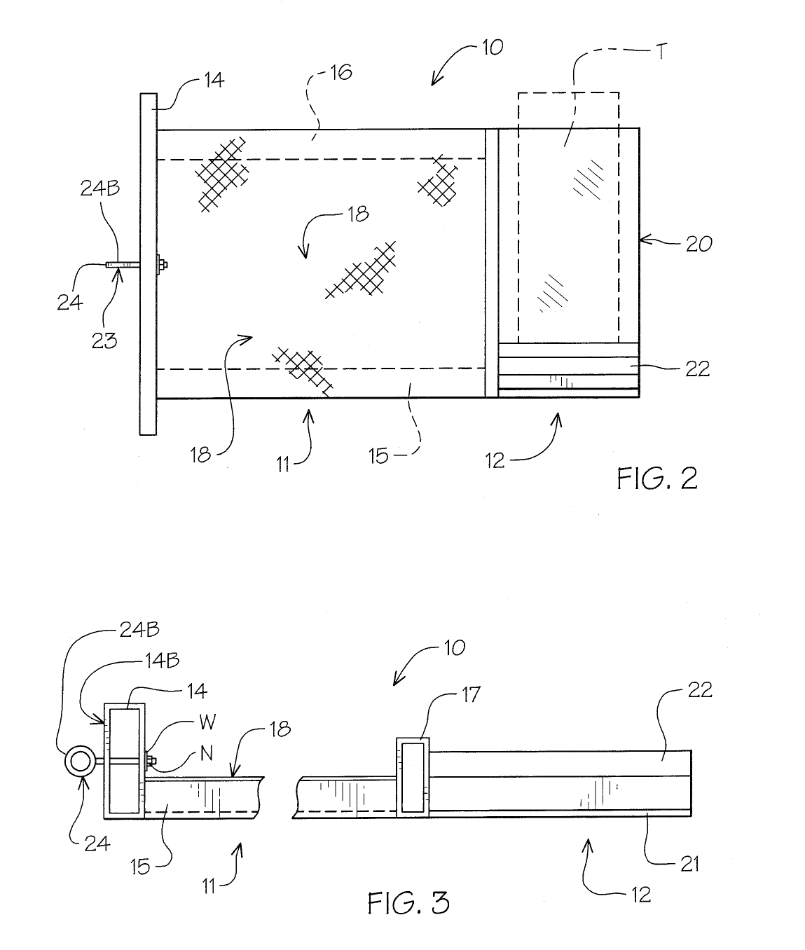

A wheel chalk 22 (as is well understood within the art) is secured to the surface of the parking plate 21 inwardly from one end 22A and at right angles to the hereinbefore described bottom rail 17 as best seen in FIGS. 1 and 2 of the drawings.

It will be seen that the orientation of the tire platform 20 allows for vehicle tire T shown in broken lines in FIG. 2 of the drawings to be driven thereon, see directional drive arrows D and parked. It will therefore be evident that the weight of the vehicle (not shown) will effectively hold the ladder stabilization device 10 of the invention securely in place during use as will be described in greater detail hereinafter.

Referring now to FIGS. 1-3 and 6 of the drawings, a ladder retainment attachment assembly 23 can be seen having an anchor eyelet 24 secured to and through a central portion midway along the ladder engagement rail 14. The eyelet 24 has a threaded mounting shaft 24A that extends, as noted, through aligned aperture A in the rail with a washer W and lock nut N threadably disposed thereon against an inner surface 14A of the rail 14. The eyelet 24 therefore defines an engagement ring portion 24B on the rail's 14 outer surface 14B as best seen in FIGS. 2 and 3 of the drawings.

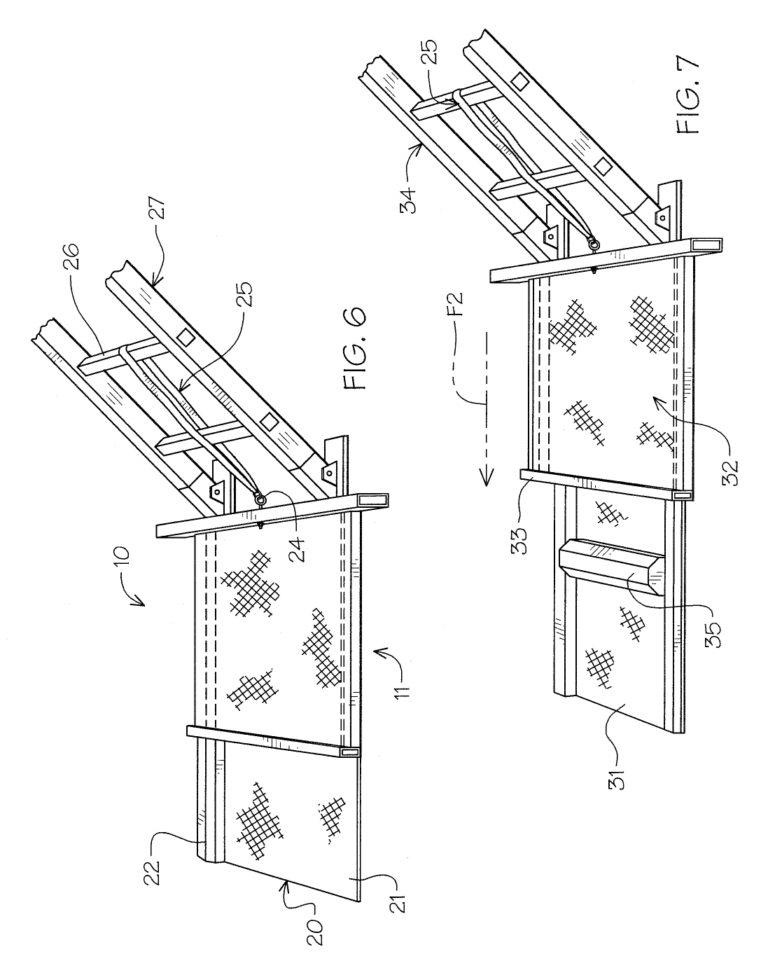

An elastic strap and hook assembly 25 may be attached to the ring portion 24A extending up over a ladder rung 26 of an extension ladder 27 so illustrated and back down to the ring portion 24A so as to secure the ladder 27 when it is positioned up against the ladder engagement rail as seen clearly in FIG. 6 of the drawings for use.

As shown, once the ladder stabilizer 10 of the invention is properly positioned and engaged with the vehicle tire T and the ladder 27 is engaged and secured there against the user (not shown) can easily and safely climb the ladder from the user's access platform 13 will correspondingly dismount from the ladder 27 being assured of a safe, stabile, flat level surface to step.

Referring now to FIG. 7 of the drawings, an alternate form of the invention 30 can be seen wherein a tire engagement platform 31 in this case has been repositioned in relation to a main user access platform 32 so as to be directly opposite a ladder bottom base rail 33 thereon affording a directional force transfer line indicated by force arrows F1 and F2 between a so positioned and secured ladder 34 and the effective intrinsic mass of the vehicle (not shown) imparted thereon assist a wheel stop check 35.

It will thus be seen that a new and novel ladder stabilization and safety device has been illustrated and described and it will be apparent to those skilled in the art that various changes and modifications may be made thereto.

Therefore I claim:

1. A ladder stabilization support for use against a ladder having at least one rail to prevent the ladder from sliding on its engagement surface comprising,
a user access portion and a vehicle tire engagement portion,
said user access portion having a raised platform and an upstanding ladder engagement rail,
said vehicle tire engagement portion having a tire platform extending from and integral with said user access platform,
a vehicle wheel stop on said tire platform,
ladder retainment means extending from said upstanding ladder engagement rail for selectively securing said ladder against the upstanding ladder engagement rail.

2. The ladder stabilization support set forth in claim 1 wherein said raised user access platform has an upstanding bottom rail in spaced parallel relation to said upstanding ladder engagement rail.

3. The ladder stabilization support set forth in claim 2 wherein said vehicle wheel stop extends at a right angle from said upstanding bottom rail.

4. The ladder stabilization support set forth in claim 1 wherein said ladder retainment means comprises,
an elastic strap and hook extending from an anchor on said upstanding ladder engagement rail to a ladder rung on a ladder supported by said ladder stabilization support.

5. The ladder stabilization support set forth in claim 2 wherein said upstanding ladder engagement rail and said upstanding bottom rail extend above the surface of said raised platform.

6. The ladder stabilization support set forth in claim 2 wherein said upstanding ladder engagement rail and said upstanding bottom rail are hollow and made of metal.

7. The ladder stabilization support set forth in claim 1 wherein said raised platform is supported on a pair of parallel spaced side rails extending from said upstanding ladder support rail.

8. The ladder stabilization support set forth in claim 1 wherein said raised platform has a textured slip resistant surface.

9. The ladder stabilization support set forth in claim 1 wherein said vehicle wheel stop further comprises, in spaced parallel relation to an upstanding bottom rail.
